(19) United States
(12) Patent Application Publication
(10) Pub. No.: US 2008/0122747 A1
(43) Pub. Date: May 29, 2008

(54) Plasma display device and driving method thereof

(76) Inventor: Seunghun Chae, Yongin-si (KR)

Correspondence Address: LEE & MORSE, P.C., 3141 FAIRVIEW PARK DRIVE, SUITE 500, FALLS CHURCH, VA, 22042, US

(21) Appl. No.: 11/984,268

(22) Filed: Nov. 15, 2007

(30) Foreign Application Priority Data
Nov. 27, 2006 (KR) 10-2006-117888

(51) Int. Cl. G09G 3/28

(52) U.S. Cl. 345/60

(57) ABSTRACT

Exemplary embodiments relate to a plasma display device, including a display panel, an image board having an image processor mounted thereon, a logic board having a logic controller mounted thereon, a driver to drive the display panel according to the driving control signals of the electrode, an abnormality detector to detect an abnormality of a transmission signal between at least one of the image board and the logic board, and a On Screen Display (OSD) processor configured to detect a result of the abnormality detector to the display panel. The image processor may convert exterior image signals received from outside into interior image signals. The logic controller may generate driving control signals of an electrode according to the interior image signals.

### BACKGROUND OF THE INVENTION

1. Field of the Invention

Exemplary embodiments relate to a display device, more particularly, to a plasma display device and driving method thereof.

2. Description of the Related Art

A plasma display device may be a display device having a plasma display panel for displaying characters and/or images using plasma generated by gas discharge. Over tens or hundreds of millions of pixels (i.e., discharge cells) depending on the size may be arranged in matrix type in the plasma display panel.

The plasma display panel of the plasma display device may be driven with one frame being classified into a plurality of subfields having respective weight value. Each subfield may include a reset period, an address period, and a sustain period. The reset period may initialize discharge cells to steadily perform the address discharge. The address period may select a cell to be turned on and off in the display panel. The sustain period may perform sustain discharge for displaying a picture corresponding to the cell to be turned on.

Further, the plasma display device may receive exterior image signals through transmission lines between an image board and a logic board, and may display image signals on the plasma display panel.

However, when the image signals are irregularly received through the transmission lines between the image board and the logic board due to an abnormality on the image board (e.g., no signals may be transmitted), the conventional plasma display device may not be capable of displaying information on the abnormality of the image board to a user.

Moreover, the conventional plasma display device may not be capable of displaying information of the abnormality to the user when the abnormality occurs on the logic board.

Accordingly, when abnormality is present on the image board and/or logic board, the user or repairman may not be able to retrieve information of the abnormalities, e.g., an indication that abnormalities may be present in the plasma display device. Thus, the user or repairman may not immediately respond (and repair) to the abnormalities.

### SUMMARY OF THE INVENTION

Example embodiments are therefore directed to a plasma display device and a method thereof, which substantially overcome one or more of the problems due to the limitations and disadvantages of the related art.

It is therefore a feature of example embodiments to provide a plasma display device and method thereof in which a user may detect abnormalities on an image board and/or a logic board by displaying the abnormalities on a display panel.

At least one of the above and other features of example embodiments may provide a plasma display device, including a display panel, an image board having an image processor mounted thereon, a logic board having a logic controller mounted thereon, a driver to drive the display panel according to the driving control signals of the electrode, an abnormality detector to detect an abnormality of a transmission signal between at least one of the image board and the logic board, and a On Screen Display (OSD) processor configured to detect a result of the abnormality detector to the display panel. The image processor may convert exterior image signals received from outside into interior image signals. The logic controller may generate driving control signals of an electrode according to the interior image signals.

At least one of the above and other features of example embodiments may provide a driving method of a plasma display device including a display panel, an image board having an image processor mounted thereon, the image processor may convert exterior image signals received from outside into interior image signals, a logic board having a logic controller mounted thereon, the logic controller may generate driving control signals of an electrode according to the interior image signals, and a driver to drive the display panel according to the driving control signals of the electrode. The method may include detecting an abnormality of a transmission signal between at least one of the image board and the logic board by an abnormality detector, and configuring the detected result of the abnormality detector to a display panel by an On Screen Display (OSD) processor.

### BRIEF DESCRIPTION OF THE DRAWINGS

The above and other features and advantages of the present invention will become more apparent to those of ordinary skill in the art by describing in detail exemplary embodiments thereof with reference to the attached drawings, in which:

FIG. 1 illustrates a block diagram of a plasma display device according to an exemplary embodiment;

FIG. 2 illustrates a view of an OSD function displayed on a display panel when an abnormality detector depicted in FIG. 1 detects a defect of an image board;

FIG. 3 illustrates a block diagram of a plasma display device according to another exemplary embodiment;

FIG. 4 illustrates a view of an OSD function displayed on a display panel when an abnormality detector depicted in FIG. 3 detects abnormal signals;

FIG. 5 illustrates a block diagram of a plasma display device according to another exemplary embodiment;

FIG. 6 illustrates a view of an OSD function displayed on a display panel when an abnormality detector depicted in FIG. 5 detects a defect of a logic board; and

FIG. 7 illustrates a flow chart of a method of displaying on a display panel by detecting abnormalities of an image board and/or a logic board in the driving method of the plasma display device.

### DETAILED DESCRIPTION OF THE INVENTION

Korean Patent Application No. 10-2006-0117888, filed on Nov. 27, 2006, in the Korean Intellectual Property Office, and entitled: “Plasma Display Device and Driving Method Thereof,” is incorporated by reference herein in its entirety.

Example embodiments will now be described more fully hereinafter with reference to the accompanying drawings. Exemplary embodiments may, however, be embodied in different forms and should not be construed as limited to the embodiments set forth herein. Rather, these example embodiments are provided so that this disclosure will be thorough and complete, and will fully convey the scope of the invention to those skilled in the art.

In the figures, the dimensions of layers and regions may be exaggerated for clarity of illustration. It will also be understood that when an element or layer is referred to as being “on”, “connected to” or “coupled to” another element or layer, it can be directly on, connected or coupled to the other element or layer or intervening elements or layers may be present. In contrast, when an element is referred to as being “directly on,” “directly connected to” or “directly coupled to” another element or layer, there are no intervening elements or layers present. Further, it will be understood that when a layer is referred to as being “under” or “above” another layer, it can be directly under or directly above, and one or more intervening layers may also be present. In addition, it will also be understood that when a layer is referred to as being “between” two layers, it can be the only layer between the two layers, or one or more intervening layers may also be present. Like numbers refer to like elements throughout. As used herein, the term “and/or” includes any and all combinations of one or more of the associated listed items.

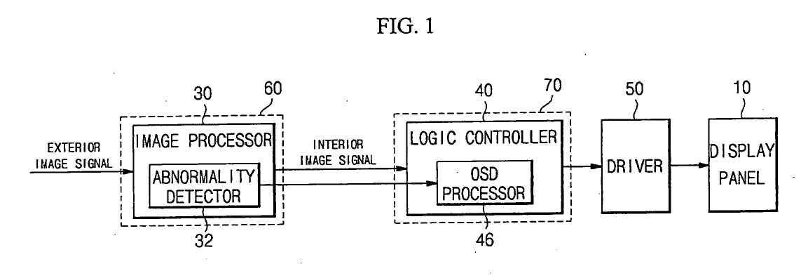

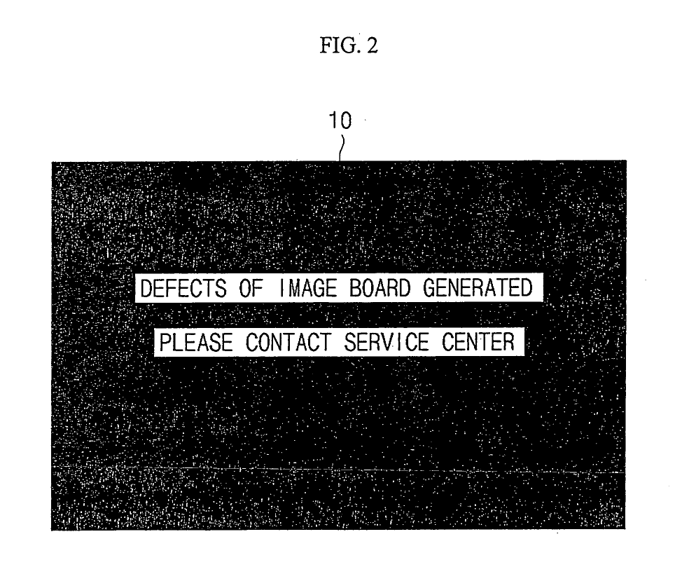

FIG. 1 illustrates a block diagram of a plasma display device according to an exemplary embodiment, and FIG. 2 illustrates a view of an OSD function displayed on a display panel when an abnormality detector depicted in FIG. 1 detects a defect of an image board.

Referring to FIG. 1, the plasma display device according to an exemplary embodiment may include a display panel 10, an image processor 30, a logic controller 40, and a driver 50.

The display panel 10 may include a plurality of address electrodes which may extend in a column direction, and a plurality of sustain and scan electrodes which may extend in a row direction in pair. Each sustain electrode may correspond to each scan electrode, and a row electrode may be formed by a neighboring sustain electrode and scan electrode. The address electrode may be formed to cross the sustain and scan electrodes and a discharge space disposed in a crossing portion of the address electrode. The sustain electrode and the scan electrode may form a discharge cell.

It should be appreciated that the address electrodes, the sustain electrodes and the scan electrodes may be arranged in other configurations besides the ones mentioned above.

The image processor 30 may be mounted on an image board 60, and may convert exterior analog image signals received from outside into digital signals to generate interior image signals, e.g., clock signals, horizontal synchronize signals, and/or vertical synchronize signals. One skilled in the art should appreciate that other interior image signals may be generated.

An abnormality detector 32 detecting self-defects of the image board 60 may be mounted on the image board 60. In addition, the abnormality detector 32 may be disposed, e.g., embedded, in the image processor 30. It should be appreciated that the abnormality detector 32 may be disposed in other locations and/or elements. A control signal regarding the abnormality of the image board 60 may be output by the abnormality detector 32 so that electrical components formed in the image board 60 may indicate abnormal conditions, e.g., a short.

The logic controller 40 may be mounted on a logic board 70, and may generate driving control signals of the address electrodes, the scan electrodes, and the sustain electrodes according to the interior image signals from the image processor 30. It should be appreciated that the logic controller 40 may generate other signals besides the ones mentioned above.

An On Screen Display (OSD) processor 46 may be mounted on the logic board 70 on which the logic controller 40 may be mounted. The OSD processor 46 may be disposed, e.g., embedded, in the logic controller 40. It should be appreciated that the OSD processor 46 may be disposed at other locations and/or elements. The OSD processor 46 may receive a control signal regarding the abnormality of the image board 60 from the abnormality detector 32. Accordingly, the OSD processor 46 may generate control signals by generating a text representing abnormal conditions of the image board 60. The control signals regarding the abnormal conditions of the image board 60 may be provided along with the driving control signals of the address electrodes, the scan electrodes, and the sustain electrodes.

The driver 50 may drive the display panel 10 according to the driving control signals of the address electrodes, the scan electrodes, and the sustain electrodes from the logic controller 40. It should be appreciated that the driver 50 may generate other signals besides the ones mentioned above.

Once the driver 50 receives the driving control signals of the address electrodes, the scan electrodes and the sustain electrodes, including control signals of a text representing the abnormal conditions inside the image board 60, the driver 50 may generate respective driving signal of the address electrodes, the scan electrodes, and the sustain electrodes to be applied to the display panel 10. The display panel 10 may display the text representing the abnormal conditions of the image board 60, i.e., “Defects of Image Board Generated, Please Contact Service Center” (as shown in FIG. 2). Accordingly, the user may initially recognize defects of the image board 60, and then contact the service center to inform (or repair) the image board 60. Further, the defect information of the image board 60 may be provided to the display panel 10 in detail, and thus, the time in repairing the image board 60 may be reduced.

Further, the plasma display device according to an exemplary embodiment may display an OSD function displaying the text of the abnormality on the display panel 10 using the OSD processor 46 and abnormality detector 32. Accordingly, the user may recognize the abnormal conditions of the plasma display device, and then response promptly against the abnormal conditions.

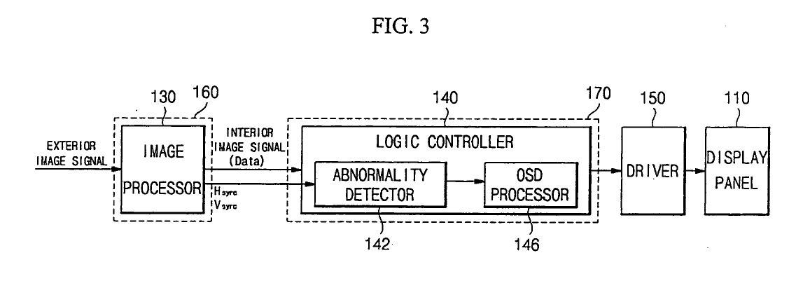

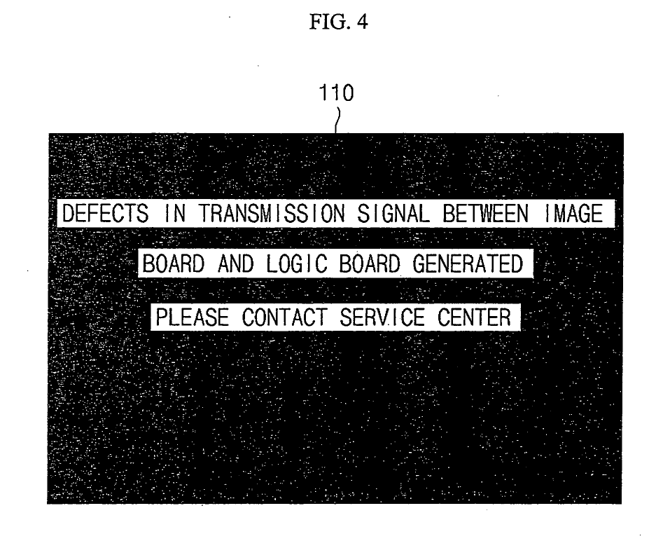

FIG. 3 illustrates a block diagram of a plasma display device according to another exemplary embodiment, and FIG. 4 illustrates a view of an OSD function displayed in a display panel when an abnormality detector depicted in FIG. 3 detects abnormal signals.

The plasma display device according to FIG. 3 may have the same components as the plasma display device of FIG. 1, except that an abnormality detector 142 detecting the abnormality of the transmission signals may be disposed on a logic board 170. Thus, similar reference numerals refer to the same elements and any further illustrations with respect to the same elements are omitted herein for brevity.

Referring to FIG. 3, the plasma display device according to this exemplary embodiment may include a display panel 110, an image processor 130, a logic controller 140, and a driver 150.

The logic controller 140 may include an abnormality detector 142 and an OSD processor 146. It should be appreciated that other elements and/or devices may be included in the logic controller 140.

The abnormality detector 142 may be mounted on the logic controller 140. It should further be appreciated that the abnormality detector 142 may also be mounted on the logic board 170 apart from the logic controller 142. The abnormality detector 142 may detect the abnormality of a transmission signal, such as, but not limited to, an interior image signal (Data), a horizontal synchronize signal (Hsync) and/or a vertical synchronize signal (Vsync), communicating between an image board 160 (on which the image processor 130 may be mounted) and the logic board 170 (on which the logic controller 140 may be mounted). The abnormality of transmission signals may be at least one of which the interior image signal (Data), the horizontal synchronize signal (Hsync) and the vertical synchronize signal (Vsync) may be received in a wrong mode and/or the signal itself is not received.

For example, when the transmission signal from the image processor 130 is input to the logic controller 140 with a LVDS (Low Voltage Differential Signaling) mode, e.g., the transmission signal received in a wrong mode and/or a wrong value, the abnormality detector 142 may determine that the abnormality may be present in the transmission signal between the image board 160 and the logic board 170, and may then generate a control signal regarding the abnormality of the transmission signal.

When the abnormality detector 142 generates a control signal regarding the abnormality of the transmission signal, the OSD processor 146 coupled to the abnormality detector 142 may receive a control signal regarding abnormality of the transmission signal so as to generate a text representing the abnormality of the transmission signal. In this exemplary embodiment, the control signal generating the text to represent the abnormality of the transmission signal may be generated along with the driving control signals of the address electrodes, the scan electrodes, and the sustain electrodes.

The driver 150 may receive driving control signals of the address electrodes, the scan electrodes, and the sustain electrodes along with the control signal that generates the text to represent the abnormality of the transmission signal from the logic controller 140. The driver 150 may then generate respective driving signals of the address electrodes, the scan electrodes, and the sustain electrodes to be applied to the display panel 110. The display panel 110 may display the text representing the abnormality of the transmission signal, i.e., “Defects in Transmission Signal Between Image Board and Logic Board Generated (as shown in FIG. 4). Accordingly, the user may initially recognize the abnormality of the transmission signal between the logic board 170 and the image board 160, and then repair the logic board 170 and the image board 160 relating to the abnormality of the transmission signal between the image board 160 and the logic board 170 by contacting the service center. Because the defect information for the transmission signal between the logic board 170 and the image board 160 may be displayed on the display panel 110, the repair time may be reduced by examining only the image board 160 and/or the logic board 170.

Thus, the plasma display device according to the exemplary embodiments may provide an OSD function displaying the text regarding the abnormality of the display panel 110 using the OSD processor 146 and the abnormality detector 142 when the abnormality in the transmission signal is generated between the logic board 170 and the image board 160. As a result, the user may initially recognize the defects or errors of the plasma display device, and then response promptly against the defects or errors of the plasma display device.

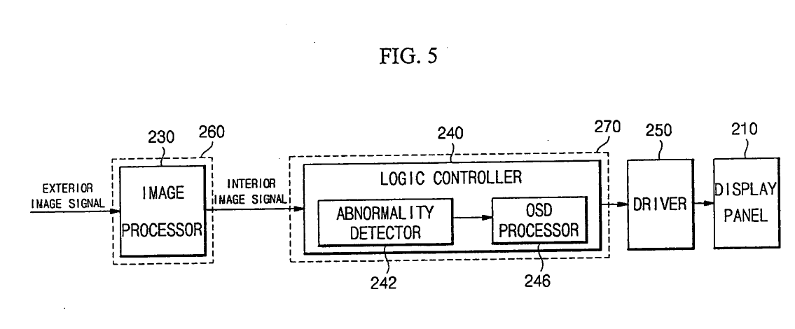

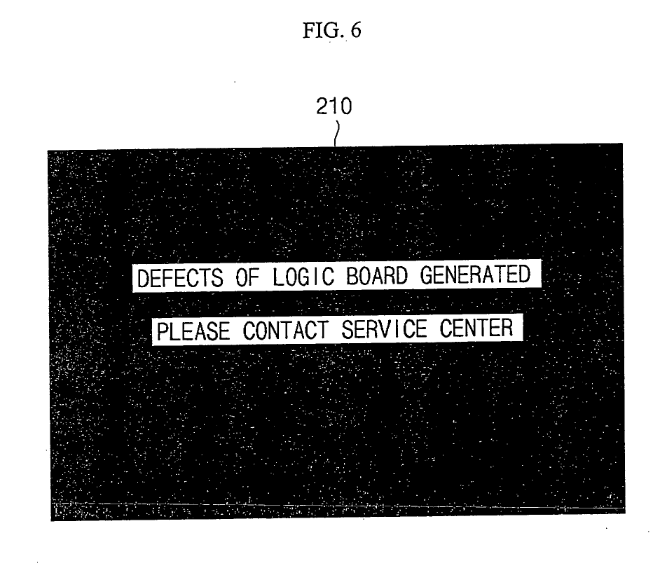

FIG. 5 illustrates a block diagram of a plasma display device according to another exemplary embodiment, and FIG. 6 illustrates a view displaying an OSD function in a display panel when an abnormality detector depicted in FIG. 5 detects a defect of a logic board.

The plasma display device of FIG. 5 may have the same components as compared with the plasma display panel device described in FIG. 1, except that an abnormality detector 242 may be formed on a logic board 270 to determine a defect or error in the logic board 270. Thus, similar reference numerals refer to the same elements and any further illustrations with respect to the same elements are omitted herein for brevity.

Referring to FIG. 5, the plasma display device may include a display panel 210, an image processor 230, a logic controller 240, and a driver 250.

The logic controller 240 may include the abnormality detector 242 and an OSD processor 246. It should be appreciated that other elements and/or devices may be included in the logic controller 240.

The abnormality detector 242 may be mounted in the logic controller 240. It should be appreciated that the abnormality detector 242 may also be mounted on the logic board 270 apart from the logic controller 240 to detect a defect inside the logic board 270. The abnormality detector 242 may output a control signal regarding the abnormality condition of the logic board 270, e.g., the logic board 270 may not have the proper determined values and/or abnormal conditions may be present, e.g., a short.

The OSD processor 246 coupled to the abnormality detector 242 may receive a control signal regarding the abnormality of the logic board 270 from the abnormality detector 242. Accordingly, the OSD processor 246 may generate a control signal for a text representing defects or errors in the logic board 270. The control signal for the text representing the defects or errors of the logic board may be provided with driving control signals of the address electrodes, the scan electrodes, and the sustain electrodes.

The driver 250 may receive the driving control signals of the address electrodes, the scan electrodes, and the sustain electrodes along with the control signal of the text representing the defects or errors inside the logic board 270. The driver 250 may then generate respective driving signal of the address electrodes, the scan electrodes, and the sustain electrodes responding to the received control signals and provided to the display panel 210. The display panel 210 may display the text representing the defects or errors of the logic board 270, i.e., “Defects of Logic Board Generated, Please Contact Service Center” (as shown in FIG. 6). Accordingly, the user may initially recognize defects or errors of the logic board 270 and then repair the logic board 270 by contacting the service center. As a result, information on the defects or errors of the logic board 270 may be provided to the display panel 210 in detail, and thus, the repair time may be reduced as only the logic board 270 may be checked for errors.

Accordingly, the plasma display device according to the exemplary embodiments may provide an OSD function displaying the text of the abnormality of the display panel 210 using the OSD processor 246 and the abnormality detector 242 when the abnormality is generated. Accordingly, the user may initially recognize the defects or errors of the plasma display device, and then response promptly against the defects or errors of the plasma display device.

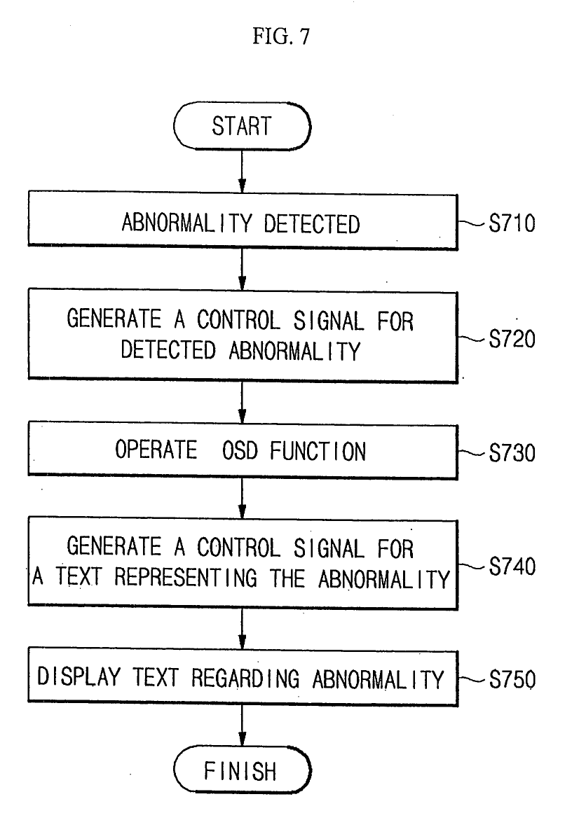

FIG. 7 illustrates a flow chart describing a method of displaying in the display panel by detecting abnormalities of an image board or a logic board in a driving method of the plasma display device.

In S710, an abnormality detector may detect abnormalities in the image board, for example. Then in S720, the abnormality detector may generate a control signal for the abnormalities in the image board by determining abnormalities of electrical components, e.g., a short, which may be caused by an open among the electrical components of the image board, when the abnormality detector is mounted on the image board.

Further, the abnormality detector may generate a control signal for the abnormalities of a transmission signal by determining abnormalities in the transmission signal between the image board and the logic board.

Further, the abnormality detector may generate a control signal for the abnormalities of the logic board by determining the abnormalities of electrical components, e.g., a short, when the abnormality detector is mounted on the logic board.

In S730, an OSD function may be operated when an OSD processor mounted on the logic board may be coupled to the abnormality detector to thereby generate a control signal for a text according to the control signal of the abnormalities from the abnormality detector.

More specifically, in S740, the OSD processor may generate a control signal for the text representing the defects of the image board after receiving the control signal that a defect is present in the image board. Further, the OSD processor may generate a control signal for the text representing the error of the transmission signal between the image board and the logic board after receiving the control signal that an abnormality condition is present in the transmission signal between the logic board and the image board. Even further, the OSD processor may generate a control signal for the text representing the defects after receiving the control signal of an abnormality condition is present in the logic board.

In S750, the driver coupled to the OSD processor may then display the text regarding the defect of the image board, the defect of transmission signal between image and logic board, and/or the defect of the logic board in the display panel according to the control signals about the text received from the OSD processor. It should be appreciated that the driver may display other defects or errors besides the ones mentions above.

Accordingly, the user may initially recognize the defect of the plasma display device through the text displayed in the display panel, and then response promptly against the defects of the plasma display device.

Further, other exemplary embodiments may include an abnormality detector for detecting abnormalities of transmission signal between the image board and/or the logic board, and an OSD processor for controlling the abnormality of the transmission signal between the image board and/or the logic board to the display panel according to a control signal from the abnormality detector. Thus, the plasma display device and the driving method thereof according to exemplary embodiments may inform the user of abnormalities when abnormalities of transmission signals between the image board and/or the logic board are generated, and then response accordingly.

Accordingly, when requesting a repair of the plasma display device to the service center, the repair time may be reduced by providing detailed information of the defects of the plasma display device.

Exemplary embodiments of the present invention have been disclosed herein, and although specific terms are employed, they are used and are to be interpreted in a generic and descriptive sense only and not for purpose of limitation. Accordingly, it will be understood by those of ordinary skill in the art that various changes in form and details may be made without departing from the spirit and scope of the present invention as set forth in the following claims.

What is clamed is:

1. A plasma display device, comprising:
a display panel;
an image board having an image processor mounted thereon, the image processor adapted to convert exterior image signals received from outside into interior image signals;
a logic board having a logic controller mounted thereon, the logic controller adapted to generate driving control signals of an electrode according to the interior image signals;
a driver adapted to drive the display panel according to the driving control signals of the electrode;
an abnormality detector adapted to detect at least one abnormality of the image board and the logic board; and
a On Screen Display (OSD) processor adapted to detect a result of the abnormality detector to the display panel.

2. The plasma display device as claimed in claim 1, wherein the abnormality detector is mounted on the image board.

3. The plasma display device as claimed in claim 2, wherein the abnormality detector is mounted in the image processor, and adapted to detect self-defects of the image board.

4. The plasma display device as claimed in claim 2, wherein the OSD processor is mounted on the logic board.

5. The plasma display device as claimed in claim 4, wherein the OSD processor is mounted in the logic controller, and adapted to generate a control signal for information regarding defects of the image board and adapted to display a text on the display panel.

6. The plasma display device as claimed in claim 1, wherein the abnormality detector is mounted on the logic board.

7. The plasma display device as claimed in claim 6, wherein the abnormality detector is mounted in the logic controller, and adapted to detect states of the transmission signal communicating between the image board and the logic board.

8. The plasma display device as claimed in claim 6, wherein the transmission signal is at least one of the interior image signals, a horizontal synchronize signal and a vertical synchronize signal.

9. The plasma display device as claimed in claim 6, wherein the OSD processor is mounted on the logic board.

10. The plasma display device as claimed in claim 9, wherein the OSD processor is mounted in the logic controller, and adapted to generate a control signal for information regarding abnormality of the transmission signal and adapted to display a text on the display panel.

11. The plasma display device as claimed in claim 6, wherein the abnormality detector is mounted in the logic controller, and adapted to detect self-defects of the logic board.

12. The plasma display device as claimed in claim 6, wherein the OSD processor is mounted on the logic board.

13. The plasma display device as claimed in claim 12, wherein the OSD processor is mounted in the logic controller, and adapted to generate a control signal for information regarding defects of the logic board and adapted to display a text on the display panel.

14. A driving method of the plasma display device including a display panel, an image board having an image processor mounted thereon, the image processor adapted to convert exterior image signals received from outside into interior image signals, a logic board having a logic controller mounted thereon, the logic controller adapted to generate driving control signals of an electrode according to the interior image signals, and a driver adapted to drive the display panel according to the driving control signals of the electrode, comprising:
detecting an abnormality of a transmission signal between at least one of the image board and the logic board by an abnormality detector; and
configuring the detected result of the abnormality detector to a display panel by an On Screen Display (OSD) processor.

15. The driving method of the plasma display device as claimed in claim 14, wherein the detection of abnormality of the transmission signal is detected when the abnormality detector is mounted in the image board and adapted to detect self-defects of the image board.

16. The driving method of the plasma display device as claimed in claim 15, wherein the operation of the OSD function to the display panel is generated when the OSD processor is mounted in the logic board, and adapted to generate a control signal for information regarding defects of the image board and adapted to display a text on the display panel.

17. The driving method of the plasma display device as claimed in claim 14, wherein the detection of abnormality of the transmission signal is detected when the abnormality detector is mounted in the logic board, and adapted to detect self-defects of the logic board.

18. The driving method of the plasma display device as claimed in claim 17, wherein the operation of the OSD function to the display panel is generated when the OSD processor is mounted in the logic board, and adapted to generate a control signal for information regarding defects of the image board and adapted to display a text on the display panel.

19. The driving method of the plasma display device as claimed in claim 14, wherein the detection of the abnormality of the transmission signal between the image board and the logic board is generated by a control signal regarding the abnormality in the transmission signal between the image board and the logic board when the abnormality detector is mounted in the logic board so as to detect the abnormality in the transmission signal communicating between the image board and the logic board.

20. The driving method of the plasma display device as claimed in claim 19, wherein the operation of the OSD function to the display panel is generated when the OSD processor is mounted in the logic board to generate a control signal for information regarding defects of the image board, and configured to display a text on the display panel.
